(19) United States
(12) Patent Application Publication
(10) Pub. No.: US 2004/0162677 A1
(43) Pub. Date: Aug. 19, 2004

(54) Method and system for distributed tomographic velocity analysis using dense p-maps

(75) Inventors: J. Bee Bednar, Houston, TX (US); Houzhu Zhang, Houston, TX (US); Chengbin Peng, Houston, TX (US)

Correspondence Address: PAUL S MADAN, MADAN, MOSSMAN & SRIRAM, PC, 2603 AUGUSTA, SUITE 700, HOUSTON, TX, 77057-1130, US

(73) Assignee: Core Laboratories, LP

(21) Appl. No.: 10/679,890

(22) Filed: Oct. 6, 2003

Related U.S. Application Data
(60) Provisional application No. 60/416,068, filed on Oct. 4, 2002.

(51) Int. Cl. G01V 1/28

(52) U.S. Cl. 702/14; 702/16

(57) ABSTRACT

The present invention provides a method and system for distributed residual tomographic velocity analysis using dense residual depth difference maps. Prestack seismic imaging is performed using an initial velocity field and interpreted horizons. A residual depth difference is estimated referenced to fixed offset and all horizons. Residual depth difference maps are computed for each offset and each horizon. The residual depth difference maps are back projected to determine slowness perturbation. The initial velocity model may be converted to slowness and the estimated slowness is composited therewith to produce a new slowness volume. The new slowness volume is converted to a new velocity volume for performing prestack seismic imaging. This process is repeated until the slowness perturbation is negligible or reaches a predetermined threshold.

### CROSS REFERENCE TO RELATED APPLICATIONS

This application claims priority from U.S. Provisional App. Ser. No. 60/416,068 filed on Oct. 4, 2002.

### FIELD OF THE INVENTION

This invention relates to the field of seismic data processing and, more particularly, to creating velocity models for use in seismic data migration for determining subsurface earth structure represented by a 3-D volume of data for identifying structural and stratigraphic features in three dimensions.

### BACKGROUND OF THE INVENTION

Searching for subsurface mineral and hydrocarbon deposits comprises data acquisition, analysis, and interpretation procedures. Data acquisition involves energy sources generating signals propagating into the earth and reflecting from subsurface geologic structures. The signals received are recorded by receivers on or near the surface of the earth. The received signals are stored as time series (seismic traces) that consist of amplitudes of acoustic energy which vary as a function of time, receiver position, and source position and, most importantly, vary as a function of the physical properties of the structures from which the signals reflect. The data are generally processed to create volumes of acoustic images from which data analysts (interpreters) create maps and images of the subsurface of the earth.

Data processing involves procedures that vary depending on the nature of the data acquired and the geological structure being investigated. A typical seismic data processing effort produces images of geologic structure. The final product of data processing sequence depends on the accuracy of these analysis procedures.

Processed seismic data are interpreted to make maps of subsurface geologic structure to aid decisions for subsurface mineral exploration. The interpreter's task is to assess the likelihood that subsurface hydrocarbon deposits are present. The assessment will lead to an understanding of the regional subsurface geology, important main structural features, faults, synclines and anticlines. Maps and models of the subsurface, both in 2D and 3D representations are developed from the seismic data interpretations. As is well known in the art, the quality and accuracy of the seismic data processing has a significant impact on the accuracy and usefulness of the interpreted data.

High quality data processing greatly simplifies data interpretation, since resources can be focused on the geologic structure since subsurface imaging can be made less ambiguous. Unfortunately, three dimensional geophysical data processing and/or modeling frequently require large computation expenses, and practitioners are forced to simplify the data processing effort as much as possible to reduce analysis time and cost.

The sheer volume of data impacts data processing considerations. Seismic survey data sets can involve hundreds of thousands of source locations, with each source location associated with many hundreds more receiver locations. Each input/output data transfer demand burdens resources independent of the computation burden.

There have been several different approaches to manage these computational resource burdens. These approaches relate to the manner in which the data acquisition exercise is designed and carried out, as well as to assumptions made during data processing. The use of available a priori geologic and geophysical information can facilitate the minimization of the seismic data acquisition effort. Such a minimization of resources reduces the amount of data that is acquired by reducing the acquisition effort.

Minimization of the computational effort is often implemented during data processing. Compromises made during data acquisition and/or processing may lead to ambiguous and/or inaccurate images. Because little is generally known of the geologic structure being investigated, the interpreter will not know the extent to images are erroneous.

It is not uncommon for significant computer resources to be involved when large or complex data volumes are processed, often involving weeks or months of actual computer processing time. The recent availability of massively parallel processor computers offers a significant opportunity to reduce overall processing times. Massively parallel processors (MPPs) can have multiple central processing units (CPUs) which can perform simultaneous computations. By efficient use of these CPUs, projects that took weeks or months of resource time previously can be reduced to a few days or a few hours. These advantages can be enhanced further when efficient algorithms are included in the MPP software.

Computational algorithms have previously been written for prior seismic analysis routines using single or just a few processors, usually using sequential computing. Sequential computing performs single procedures at any given time. Options for obtaining enhanced performance are limited when few processors are available.

MPP computing machines offer an obvious computation advantages. The total time required to process a dataset can be reduced by dividing the work to be done among the various CPUs or CPU clusters in manner such that each CPU performs useful work while other CPUs also work in parallel.

From Robert E. Sheriff's “Encyclopedic Dictionary of Exploration Geophysics” SEG Press, 2002: Tomography is a method for finding the velocity and reflectivity distribution from a multitude of observations using combinations of source and receiver locations, or of determining the resistivity distribution from conductivity measurements using a transmitter in one well and a receiver in another well. Tomography is derived from the Greek for “section drawing.” Generally space is divided into cells and the data are expressed as line integrals along raypaths through the cells. Transmission tomography involves borehole-to-borehole, surface-to-borehole, or surfaceto-surface observations. Reflection tomography involves surface-to-surface observations as in conventional reflection or refraction work. In seismic tomography, slowness or velocity, and sometimes an attenuation factor, is assigned to each cell and traveltimes and amplitudes are calculated by tracing rays through the model. The results are compared with observed times and amplitudes; the model is then perturbed and the process repeated iteratively to minimize errors. Raypaths have to be recalculated after each change of assumed velocity. Diffraction tomography involves calculations assuming least-time travelpaths according to Fermat's principle rather than Snell's law bending at cell boundaries. Layer-based tomography divides the earth into layers, allowing for lateral variation of velocity within the layers, instead of subdivision into cells. Tomographic methods include the algebraic reconstruction technique, the simultaneous reconstruction technique, and Gauss Seidel methods.

Tomography is used to compute corrections to velocities from observed traveltime errors in seismic datasets. The position of events observed on post-migration common image point gathers indicates errors that can be caused by several reasons: error in velocity, error in the depth location of reflector, or error in placing a fault. In some cases the velocity will be over corrected by assuming all the observed traveltime errors originated by velocities. Over corrected velocities will force more structural errors in deeper reflectors, and errors repeat and can increase as depth increases so that a correct velocity model cannot be obtained from further iteration. If the errors caused by misplaced horizons and fault locations can be corrected, the result is a better depth image and a better correction to the velocity model.

For large datasets parallel computation methods offer significant processing time savings, and this is true for velocity analyses as well. An option for overcoming increased computational expenses is to employ efficient parallel algorithms and techniques.

It would therefore be desirable to have a system and method that is able to perform tomographic velocity analyses efficiently on a parallel computer in a cost-effective manner. The present invention satisfies this need.

### SUMMARY OF THE INVENTION

The present invention provides a method and system for distributed residual tomographic velocity analysis using dense residual depth difference maps. Prestack seismic imaging is performed using an initial velocity field and interpreted horizons. A residual depth difference is estimated referenced to fixed offset and all horizons. Residual depth difference maps (p-maps) are computed for each offset and each horizon. The residual depth difference maps are back projected to determine slowness perturbation. The initial velocity model may be converted to slowness and the estimated slowness is composited therewith to produce a new slowness volume. The new slowness volume is converted to a new velocity volume for performing prestack seismic imaging. This process is repeated until the slowness perturbation is negligible or reaches a predetermined threshold.

### BRIEF DESCRIPTION OF THE DRAWINGS

The present invention and its advantages will be better understood by referring to the following detailed description and the attached drawings in which:

FIG. 1: Illustrates a flow chart of incremental velocity updating.

FIG. 2: Illustrates model partitioning and model sharing.

FIG. 3: Illustrates the general structure of distributed tomography.

FIG. 4A: illustrates a flow chart of an embodiment of the invention.

FIG. 4B: illustrates a flow chart of another embodiment of the invention.

FIG. 5: illustrates a computer system for carrying out an embodiment of the invention.

While the invention will be described in connection with its preferred embodiments, it will be understood that the invention is not limited thereto. On the contrary, it is intended to cover all alternatives, modifications, and equivalents which may be included within the spirit and scope of the invention, as defined by the appended claims.

### DETAILED DESCRIPTION OF THE PREFERRED EMBODIMENTS

A good macro velocity model is the key to producing good depth migration results. When the velocity is correct, Common Image Gather (CIG) reflections from different offsets should be aligned at the same depth. While this disclosure explains the concepts using CIGs, the method and system of the present invention is directly applicable to Common Angle Image Gathers (CAIG) as well. When the velocity is incorrect, it can be updated using the depth error in the CIG.

3D velocity model updating typically requires several gigabytes of memory. This is usually beyond the memory limit of a single modem computer. On PC clusters, large problems can be partitioned into small ones. Each partition can be processed independently. The final velocity is the combination of all the local models.

Distributed tomography on a PC cluster is very cost effective. It makes it possible to solve extremely large problems quickly. In addition, very large offsets can be used in the inversion process.

A macro velocity model is needed for depth migration. The kinematic information provided by this smooth velocity is the traveltime in seismic data and depth information in depth images. Depth migration and velocity estimation are coupled problems. Given a good velocity model, modem depth imaging algorithms can give satisfying results. Velocity estimation or inversion has been one of the most challenging geophysical problems. There are many ways to estimate a smooth background velocity. Prestack migration is one of them.

One approach to velocity updating is described in Bednar et al., 1999, where the depth image is sorted into CIG gathers in which at each point there is a three-parameter function: depth, offset and CDP. The principle is that reflections from one reflector at different offsets in each CDP should be mapped into one horizontal event in the depth image if there is no error in the input velocity model. For real problems, velocity models are never exact. The error in velocity usually appears as curved events in the CIGs. To determine the velocity, it is necessary to invert the depth error of each of these points in the CIG gathers.

Ray-tracing is use to compute the difference between the input traveltime and traveltime computed form the model. This residual is used to update the velocity model. Information of each ray segment needs to be recorded. Obviously, for typical 3D real problems, a large amount of memory must be used. It is almost impossible to solve the typical problems on a single computer node.

Herein disclosed is an implementation of 3D residual tomography on a distributed PC cluster. The full problem is divided into small pieces or partitions. Each small partition is solved on different node. The main issues in this method are model partition and consistency between overlapping pieces of the desired model.

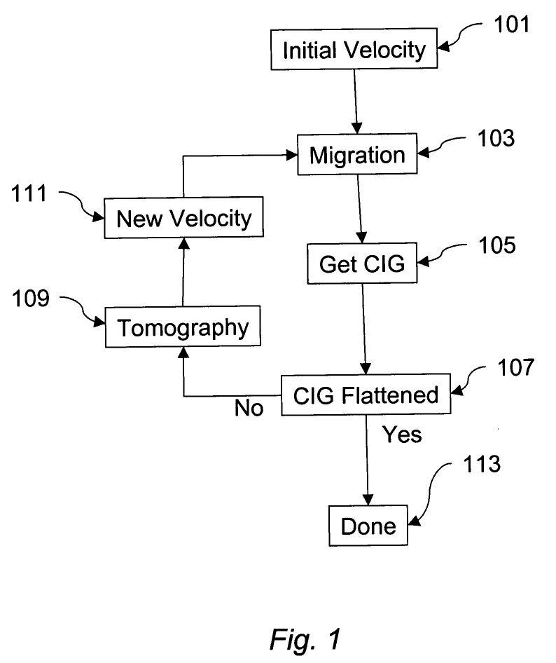

Residual Tomography CIG gather-based residual tomography updates the velocity model incrementally. The process is illustrated in the flow chart of FIG. 1. An initial velocity 101 is used to migrate 103 seismic data to get a common image gather 105. A determination is made whether the CIG is flattened 107. If the CIG is not sufficiently flattened tomography 109 is performed to derive a new velocity 111 for input to the migration 103. The cycle is repeated until the CIG is sufficiently flattened 107 and the process finishes 113.

For each iteration, the following optimization problem is solved

$$C ( m ) = {\sum }_{i = 1}^{3} {μ}_{i}^{2} {‖ {A}_{i} m - {b}_{i} ‖}^{2} \qquad ( 1 )$$

Here, Aᵢ is the linear operator that transforms the model m to the data space. Parameter bᵢ is the known data. Parameter μᵢ is a damping factor to ensure the smoothness and stability of the solution of the linear system below. Solving Equation 1 is equivalent to solving the following linear system

A^{T} Am=A^{T}b (2)

where

$$A = \vert \begin{matrix}{μ}_{1} {A}_{1} \\ {μ}_{2} {A}_{2} \\ {μ}_{3} {A}_{3}\end{matrix} \vert$$

$$and$$

$$b = \vert \begin{matrix}{b}_{1} \\ {b}_{2} \\ {b}_{3}\end{matrix} \vert .$$

Iterative methods such as conjugate gradient (Paige and Saunders, 1982) can be used to solve this large linear system.

Distributed Tomography: Residual tomography is highly automatic. Given model and data, the process can proceed until a solution is reached. The major problem with residual tomography is that input and output models are usually so large that they can not fit into the memory of one computer node. In addition to memory resources required for the model, ray tracing, used for traveltime computation, also requires a large amount of memory. In 3D the following parameters are stored: the coordinates of the two endpoints of a ray segment and the direction vector of a ray segment. The ray tracing is done for each depth point of each offset of each CDP, for each inline and for each crossline.

This is a five dimensional data space. To reduce the computation, one usually limits the number of xlines and inlines or limits the range of offsets. But too small ranges of offset or too few lines will not give reasonable or good velocity estimates. The best way is to divide the whole model into small partitions, each of which is solved in one computer or node.

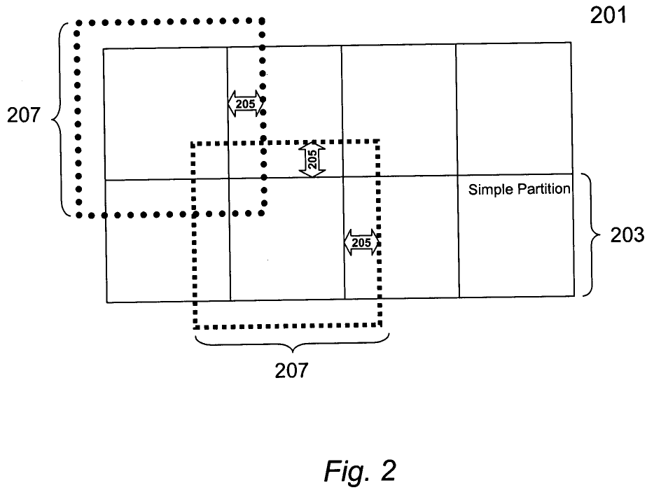

The reason we can do this is that, based on the locality principle, one point in the model space only influences on the points which fall in a circle on the surface. The radius of the circle is half of the largest offset for that CDP. Thus, we only need to consider the data within that circle in the velocity inversion of that point. This is illustrated with the portioned survey 201 of FIG. 2. For each simple partition 203, additional areas are padded in all the four sides in (x,y) domain as illustrated by the offset buffer zone 205 in FIG. 2 that represents half the offset of a seismic gather. These padded areas 205 are to be shared by the adjacent nodes.

Model Space Partition and Model Sharing: A key problem with distributed tomography is how to partition the model. The partitioning method depends on the characteristics of the model and the input depth residuals. Once partitioned, on each node, the space used by the model is relatively small compared with the space used by the ray segments. Thus, the ideal partition can be based on the density of the surface depth residual estimates. The higher the density, the smaller the model partition. This usually results in load balanced computation. In addition to this complicated partition method, other simpler methods can be used. For example, if the model is much longer in inline direction than in crossline direction, we can partition the model in inline direction.

The partition used here is an intelligent one. The user specifies the number of partitions or the number of nodes, this number is factorized into two factors which are as close as possible. For example, 12 is factorized into 3 and 4 instead of 2 and 6. Then the larger number of these two factors is assigned to the longer direction.

Simply dividing the entire model evenly and assign each piece to each node won't work well because the part of the model on one node may need data which resides on an adjacent node. In order to make sure that all the data needed for the inversion of every point in each partition are used, each piece needs to be padded before inversion. This is shown in FIG. 2. Partitions after padding are illustrated 207.

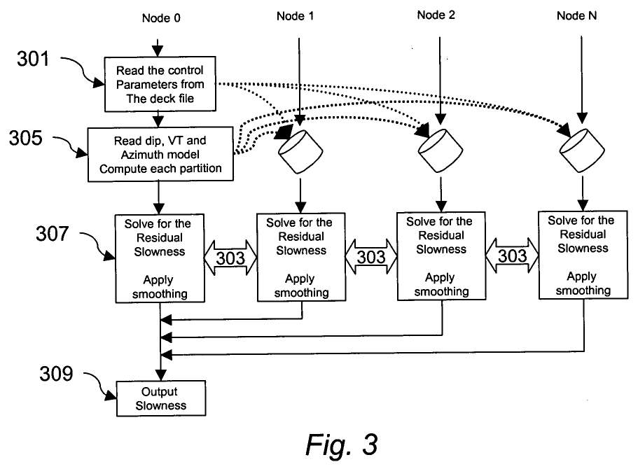

Velocity Smoothing: Smooth velocity models are critical for obtaining good depth images, especially for prestack depth migration. For distributed tomography, each node works on its own independent piece of the model. The overlapped pieces between adjacent nodes may produce different velocity estimates due to different input data on each node. To ensure the global smoothness of the velocity model, adjacent partitions need to exchange information from the overlapped areas. Global smoothing across computer nodes is illustrated in FIG. 3. Data is exchanged between nodes 303 for smoothing every several iterations. As illustrated in FIG. 3 control parameters are read from the deck file 301, and this information is shared across the nodes. Other parameters are read and computed 305. At 307 residual slowness is solved for and then smoothing is applied. The process at 307 iterates between solving for residual slowness and applying smoothing. Slowness values are output 309 after parameters have converged sufficiently.

Global smoothing is necessary during velocity updating because we want the model difference between any two nodes to be small. Global smoothing enforces model consistency between nodes and global convergence of the solution.

Obviously, frequent exchanging of data between nodes increases network overhead. This overhead can be reduced by applying global smoothing every several conjugate steps. In addition, the data transmission between nodes can be reduced further by choosing a proper partition.

The general flow of this proposed distributed tomography is given in FIG. 3 with all the major features highlighted. Data communication is based on MPI. A Master node is responsible for distributing model and data to all other nodes. After each node finishes its computation, it sends the updated local model to the master node. The master node assembles all the pieces and writes the result on to disk.

Tomography on distributed PC clusters is an excellent way to solve large velocity updating projects with a reasonable computation time and relatively small cost. By partitioning a large model in to small pieces, a high density of input depth residuals becomes possible and thus highly accurate velocity inversions are possible. Issues associated with distributed computation need special treatment. There are areas overlapping between adjacent nodes which leads to model consistency among all the nodes. Area overlapping ensures the combination of inversion on each individual nodes is equivalent to the inversion of the entire problem on one node. Global smoothing provides an additional constraint for global convergence. Performance testing demonstrates that this strategy can reduce computation time significantly and increases throughput.

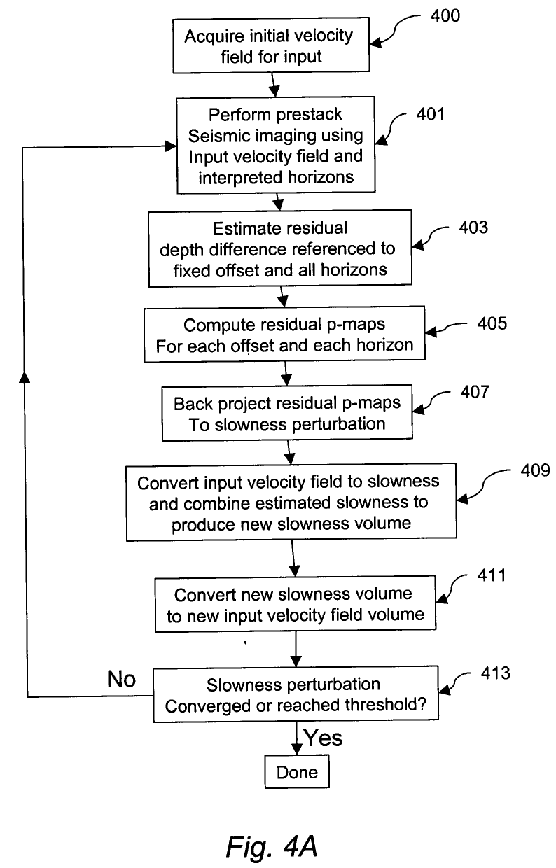

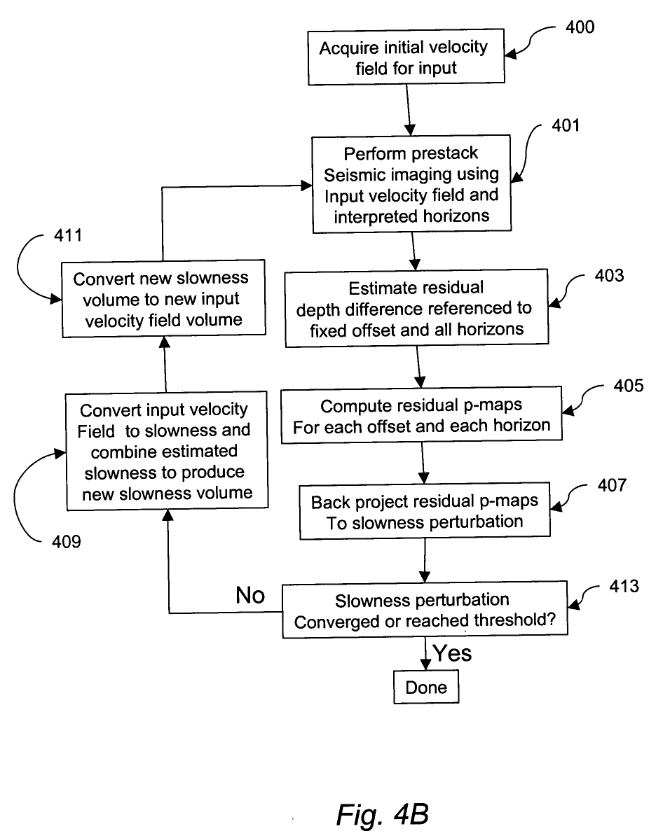

FIG. 4A illustrates a flowchart of a preferred embodiment of the method and system provided by the present invention. Prestack seismic imaging is performed 401 using an initial velocity field and interpreted horizons. A residual depth difference is estimated 403 referenced to fixed offset and all horizons. Residual depth difference maps (p-maps) are computed 405 for each offset and each horizon. The residual depth difference maps are back projected 407 to determine slowness perturbation. The initial velocity model may be converted 409 to slowness and the estimated slowness is composited therewith to produce a new slowness volume. The new slowness volume is converted 411 to a new input velocity volume for performing prestack seismic imaging. This process is repeated 413 until the slowness perturbation is negligible or reaches a predetermined threshold. FIG. 4B illustrates an alternate embodiment of the invention where the threshold for slowness perturbation is determined prior to converting slowness to a new input velocity volume.

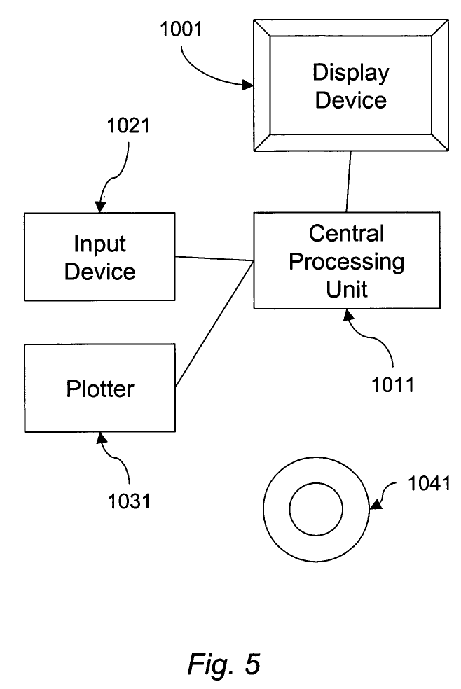

The method and system of the present invention disclosed herein may be conveniently carried out by writing a computer program to carry out the steps described herein on a work station or other conventional digital computer system of a type normally used in the industry. The generation of such a program may be performed by those of ordinary skill in the art based on the processes described herein. FIG. 5 illustrates a computer system comprising a central processing unit 1011, a display 1001, an input device 1021, and a plotter 1031. The computer program for carrying out the invention will normally reside on a storage media (not shown) associated with the central processing unit. The computer program may be transported on a CD-ROM or other storage media shown symbolically as storage medium 1041.

The method and system of the present invention provides results that may be displayed or plotted with commercially available visualization software and computer peripherals. Such software and computer peripherals are well known to those of ordinary skill in the art. It should be appreciated that the results of the methods of the invention can be displayed, plotted and/or stored in various formats.

While the invention has been described and illustrated herein by reference to embodiments in relation to the drawings attached hereto, various changes and further modifications, apart from those shown or suggested herein, may be made herein by those skilled in the art, without departing from the spirit of the invention, the scope of which is expressed in the following claims.

What is claimed is:

1. A method for processing seismic data comprising:
a) acquiring seismic data with an initial velocity field and an interpreted horizon;
b) performing prestack imaging on said seismic data;
c) estimating a residual depth difference to compute a residual depth map for said interpreted horizon;
d) back projecting residual depth difference map to determine slowness perturbation;
e) converting input velocity field to slowness to produce new slowness volume; and
f) repeating steps b) through e) until slowness perturbation has reached a predetermined threshold.

2. The method of claim 1 further comprising partitioning said velocity field into partitions with padding.

3. The method of claim 1 further comprising partitioning said velocity field into partitions with a padding distance of at least half the offset of an input seismic gather.

4. A digital computer programmed to utilize seismic data traces obtained over a region of the earth's subsurface to perform a process comprising:
a) acquiring seismic data with an initial velocity field and an interpreted horizon;
b) performing prestack imaging on said seismic data;
c) estimating a residual depth difference to compute a residual depth map for said interpreted horizon;
d) back projecting residual depth difference map to determine slowness perturbation;
e) converting input velocity field to slowness to produce new slowness volume; and
f) repeating steps b) through e) until slowness perturbation has reached a predetermined threshold.

5. The digital computer of claim 4 further programmed to perform a process for partitioning said velocity field into partitions.

6. The digital computer of claim 4 further programmed to perform a process for partitioning said velocity field into partitions with a padding distance of at least half the offset of an input seismic gather.

7. A system for processing seismic data obtained over a region of the earth's subsurface comprising:
a) acquiring seismic data with an initial velocity field and an interpreted horizon;
b) performing prestack imaging on said seismic data;
c) estimating a residual depth difference to compute a residual depth map for said interpreted horizon;
d) back projecting residual depth difference map to determine slowness perturbation;
e) converting input velocity field to slowness to produce new slowness volume; and
f) repeating steps b) through e) until slowness perturbation has reached a predetermined threshold.

8. The system of claim 7 further comprising a process for partitioning said velocity field into partitions.

9. The system of claim 7 further comprising a process for partitioning said velocity field into partitions with a padding distance of at least half the offset of an input seismic gather.
